(19) United States
(12) Patent Application Publication
(10) Pub. No.: US 2013/0240096 A1
(43) Pub. Date: Sep. 19, 2013

(54) PHASE CHANGE GRADED SMA ACTUATORS

(71) Applicants: Alan L. Browne, Grosse Pointe, MI (US); Nancy L. Johnson, Northville, MI (US); Peter Maxwell Sarosi, Ferndale, MI (US)

(72) Inventors: Alan L. Browne, Grosse Pointe, MI (US); Nancy L. Johnson, Northville, MI (US); Peter Maxwell Sarosi, Ferndale, MI (US)

(73) Assignee: GM GLOBAL TECHNOLOGY OPERATIONS LLC., Detroit, MI (US)

(21) Appl. No.: 13/422,952

(22) Filed: Mar. 16, 2012

(51) Int. Cl. F16K 31/00; C21D 8/00; C22F 1/00

(52) U.S. Cl. CPC F16K 31/002; C22F 1/00; C21D 8/00
USPC 148/563; 148/402

(57) ABSTRACT

A shape memory alloy element is disclosed that is configured to undergo a graded phase change along a dimension of the shape memory alloy element in response to thermal stimulus. This graded phase change produces a graded displacement response of the shape memory element.

### FIELD OF THE INVENTION

Exemplary embodiments of the invention are related to metallic shape memory alloy (“SMA”) actuators and, more specifically, to SMA actuators having unique thermal response characteristics.

### BACKGROUND

Shape memory alloys are well-known in the art. Shape memory alloys are alloy compositions with at least two different temperature-dependent phases. The most commonly utilized of these phases are the so-called Martensite and Austenite phases. In the following discussion, the Martensite phase generally refers to the more deformable, lower temperature phase whereas the Austenite phase generally refers to the more rigid, higher temperature phase. When the shape memory alloy is in the Martensite phase and is heated, it begins to change into the Austenite phase. The temperature at which this phenomenon starts is often referred to as the Austenite start temperature (Aₛ). The temperature at which this phenomenon is complete is called the Austenite finish temperature (A_{f}). When the shape memory alloy is in the Austenite phase and is cooled, it begins to change into the Martensite phase, and the temperature at which this phenomenon starts is referred to as the Martensite start temperature (Mₛ). The temperature at which Austenite finishes transforming to Martensite is called the Martensite finish temperature (M_{f}). It should be noted that the above-mentioned transition temperatures are functions of the stress experienced by the SMA sample. Specifically, these temperatures increase with increasing stress. In view of the foregoing properties, deformation of the shape memory alloy is typically at or below the Austenite transition temperature (at or below Aₛ). Subsequent heating above the Austenite transition temperature causes the deformed shape memory alloy sample to revert back to its permanent shape. Thus, a suitable activation signal for use with shape memory alloys is a thermal activation signal having a magnitude that is sufficient to cause transformations between the Martensite and Austenite phases.

Due to their temperature-dependent shape memory properties, shape memory alloys are used or have been proposed for use as actuators or other elements requiring controlled movement in various mechanical and electromechanical devices or other applications such as air flow control louvers, reversibly deployable grab handles, portable insulin pumps, and computer media eject mechanisms, to name a few. One commonly-used configuration is that of an SMA wire with two ‘remembered’ lengths, where the wire is attached to an element or device component that is moved between different positions by transforming the wire between longer and shorter remembered lengths. Other configurations can be utilized as well, such as an SMA actuator that can be transformed between a straight and bent shape. The thermal stimulus to transform an SMA actuator between different states can be a direct external thermal stimulus, such as heat applied from a heat source like an infrared, convective, or conductive heating element. However, in the case of an SMA wire actuator, the thermal stimulus is often applied by simply running electrical current through the wire to cause it to heat up, and terminating the current so that the wire cools down by transferring heat to the surrounding cooler environment.

The temperature at which the shape memory alloy remembers its high temperature form when heated can be adjusted by slight changes in the composition of the alloy and through thermo-mechanical processing. In nickel-titanium shape memory alloys, for example, it can be changed from above about 100° C. to below about −100° C. The shape recovery process can occur over a range of just a few degrees or exhibit a more gradual recovery. The start or finish of the transformation can be controlled to within a degree or two depending on the desired application and alloy composition. The mechanical properties of the shape memory alloy vary greatly over the temperature range spanning their transformation, typically providing shape memory effect, superelastic effect, and high damping capacity. For example, in the Martensite phase a lower elastic modulus than in the Austenite phase is observed. Shape memory alloys in the Martensite phase can undergo large deformations by realigning the crystal structure arrangement with the applied stress. The material will retain this shape after the stress is removed.

The transition of a shape memory alloy between Martensitic and Austenitic states as a function of temperature is depicted in the plot of FIG. 1 where vertical axis ξ represents the fraction of the composition in the Martensite state and the horizontal axis T represents the temperature. The upper curve shown in FIG. 1 with the accompanying arrow pointing downward and to the right depicts the transition from the Martensitic state to the Austenitic state caused by an increase in temperature, with the Aₛ and A_{f} temperatures denoted on the horizontal axis. The lower curve in FIG. 1 with the accompanying arrow pointing upward and to the left depicts the transition from the Austenitic state to the Martensitic state caused by a decrease in temperature, with the Mₛ and M_{f} temperatures denoted on the horizontal axis.

For many shape memory alloys, the change between the Martensitic state and the Austenitic state and vice versa in response to thermal stimulus can occur relatively quickly. This may be due to various factors such as the composition having a narrow temperature range between the Aₛ and A_{f} temperatures and/or between the Mₛ and M_{f} temperatures. Other factors include the electrical characteristics of the shape memory alloy being such that the temperature of an SMA wire increases quickly through the Aₛ to A_{f} temperature range when current is applied. This can lead to a relatively rapid change between remembered shapes or lengths of an SMA actuator, which is undesirable in many circumstances where a slower actuation is desired for aesthetic and/or functional reasons.

Accordingly, it is desirable to provide a shape memory alloy element where the response can be tailored to meet target actuation rates in response to a thermal stimulus.

### SUMMARY OF THE INVENTION

In an exemplary embodiment of the invention, a shape memory alloy element is configured to undergo a graded phase change along a dimension of the shape memory alloy element in response to thermal stimulus. This graded thermal change produces a graded displacement response of the shape memory element.

In an exemplary embodiment of the invention, the graded phase change in an SMA element is produced by a gradation, along a dimension of the element, in a ratio of an amount of a first metal element to a second metal element. In another exemplary embodiment, the element includes a plurality of metal elements in a crystal lattice structure, and includes a gradation, along the dimension, in a ratio of an amount of a first metal element in the crystal lattice structure to a second metal element in the crystal lattice structure. In yet another exemplary embodiment, the graded phase change of the SMA element is produced by a gradation, along a dimension of the element, in the shape memory processing of the element. In a further exemplary embodiment, the gradation in shape memory processing is produced by a gradation, along a dimension of the element, in cold working of the element. In a still further exemplary embodiment, the gradation in shape memory processing is produced by a gradation, along the dimension of the element in temperature along the dimension while cold working the element.

In yet another exemplary embodiment, a method of shape memory processing of a shape memory alloy element comprises heating the element to induce a phase transition in the shape memory alloy from Martensite to Austenite, cooling the element to induce a phase transition in the shape memory alloy from Austenite to Martensite, and cold working Martensite shape memory alloy, wherein a gradation, along a dimension of the element, in cold working is applied or a gradation in temperature is applied along the dimension during cold working.

The above features, and advantages thereby provided, along with other features and advantages are readily apparent from the following detailed description of the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1 is a plot of phase change versus temperature of a typical shape memory alloy;

FIG. 2 depicts a nickel-titanium SMA element having a continuous gradation in nickel concentration along a dimension of the element;

FIGS. 3A and 3B depict plots of SMA transformation temperature and nickel concentration along with displacement response versus time/temperature; and

FIG. 4 depicts a nickel-titanium SMA element having a non-continuous gradation in nickel concentration along a dimension of the element.

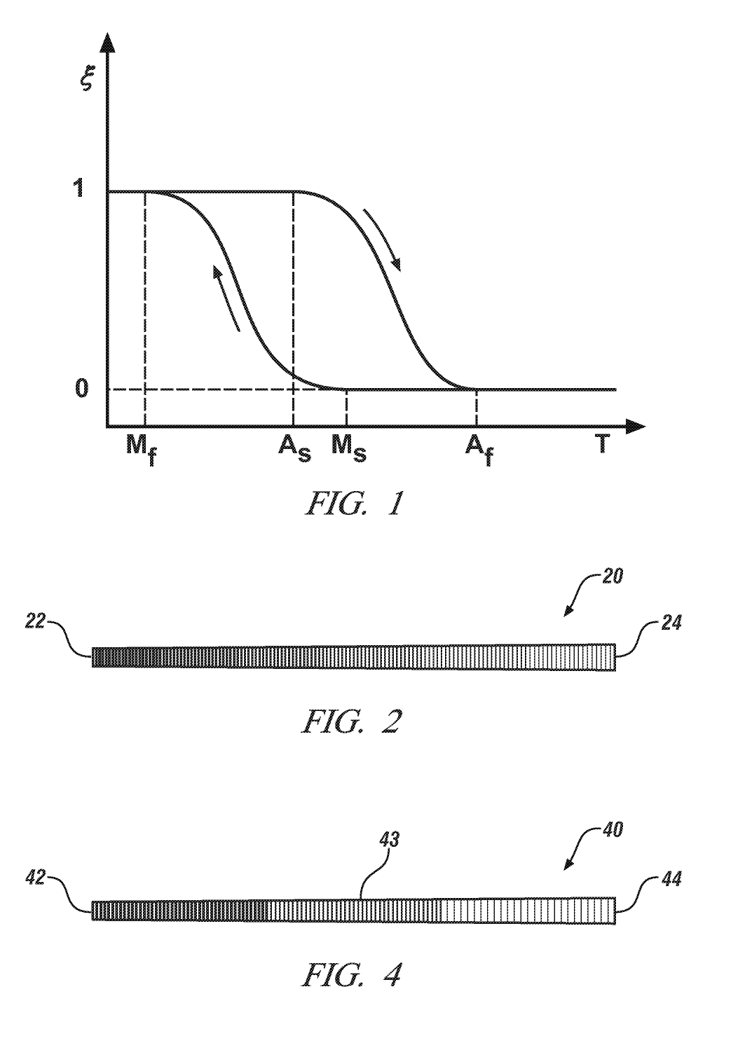

### DESCRIPTION OF THE EMBODIMENTS

In accordance with an exemplary embodiment of the invention, a shape memory alloy element is configured to undergo a graded phase change, along a dimension of the shape memory alloy element in response to thermal stimulus. By graded phase change along a dimension of the SMA element, it is meant that at a point in time, the ratio of Austenitic phase to Martensitic phase of the SMA material is different at one position along this dimension than the ratio at a different position along the dimension. Since it is the conversion of the shape memory alloy from Austenitic phase to Martensitic phase and vice versa that induces the shape memory displacement response of the SMA element, then providing a gradation in the phase change response will provide a gradation in the shape memory displacement response, as further discussed below with respect to the Figures.

Suitable shape memory alloy materials for fabricating the conformable shape memory element(s) described herein include, but are not intended to be limited to, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. The alloys can be binary, ternary, or any higher order. Selection of a suitable shape memory alloy composition depends on the temperature range where the component will operate. SMA elements typically must be worked or trained at different temperatures in order to remember different shapes between the Austenitic and Martensitic states. SMA elements may be exhibit one-way or two-way shape memory depending on the application for which they are intended, and the embodiments disclosed herein may be used with either one-way or two-way SMA elements.

SMA elements can be formed in a variety of configurations and, accordingly there is no particular limitation on the orientation of the dimension along which the SMA element exhibits a graded thermal change as long as it provides the desired displacement response of the SMA element. In an exemplary embodiment, the dimension is a linear dimension. In another exemplary embodiment, the SMA element is in the form of a shape memory alloy wire and the linear dimension is parallel to the longitudinal axis of the wire.

In an exemplary embodiment, the gradation in phase change is provided by a gradation in concentration of one or more of the metals in the shape memory alloy. Turning now to FIG. 2, there is shown a cross-sectional view of an SMA wire element 20 formed from an SMA such as a nickel-titanium alloy. The SMA wire element 20 has nickel-lean end 22 and nickel-rich end 24, with the darkness of the shading of the wire cross-section representing the relative titanium concentration, with darker regions representing high titanium and low nickel concentrations and lighter regions representing low titanium and higher nickel concentrations. As can be readily seen in FIG. 2, the darkness of the shading changes in a gradient fashion from the darkest at nickel-lean end 22, becoming progressively lighter toward nickel-rich end 24. The variation in quantity of an SMA metal such as nickel in the Ni—Ti alloy will vary depending on the particular alloy and the desired effect. In the embodiment of the Ni—Ti SMA, for example, the quantity of nickel can range from about 49 to about 51 at. %, more specifically from about 49 to about 50 at. %. One skilled in the art would be able to readily determine percentage gradation ranges for other shape memory alloys in order to practice the embodiments described herein with other known shape memory alloys.

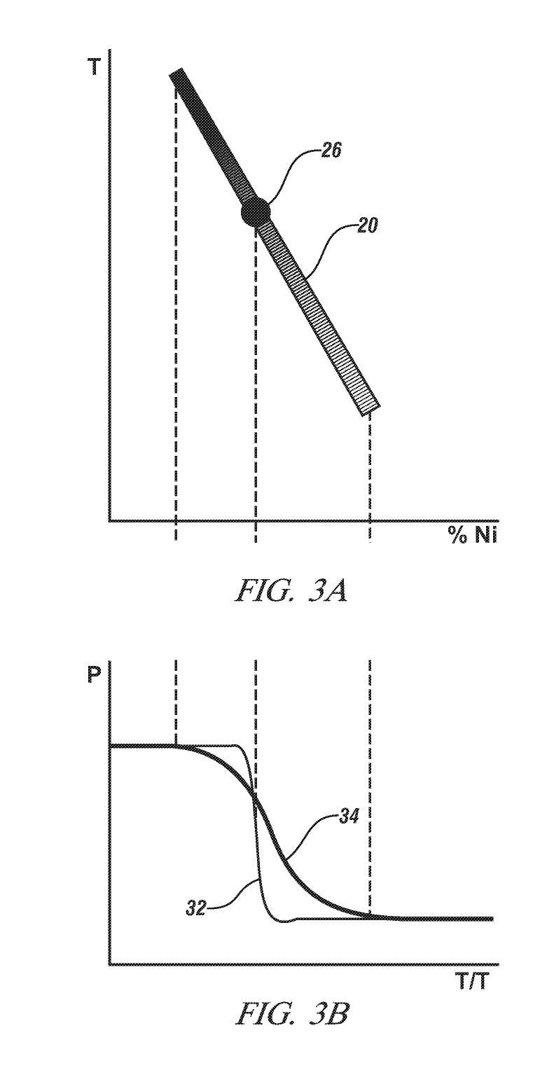

The effect of nickel concentration on shape memory performance of the SMA wire element 20 from FIG. 2 is illustrated in FIGS. 3A and 3B. FIG. 3A depicts a plot of SMA transformation temperature (T), as a function of the % nickel concentration (% Ni). For purposes of the present illustration, which depicts performance of an SMA element in response to an increase in temperature, SMA transformation temperature represents A_{S} for example, although the concept applies equally as well for Martensite transition temperatures when the SMA element is responding to a decrease in temperature. For ease of illustration, a representation of the SMA wire element 20 is used for the plot line for FIG. 3A in order to co-relate the nickel concentration gradient in SMA wire element 20 to the plot of transformation temperature versus nickel concentration. FIG. 3B represents a plot of position P (i.e., the shape memory displacement response of the SMA wire element 20) versus temperature (T) or elapsed time of thermal stimulus application (T). The curve 32 represents the displacement response of an SMA wire element having a uniform ratio of nickel to titanium taken at point 26 on the FIG. 3A plot. The curve 34 represents the displacement response of the SMA wire element 20 having a variable gradient along its length in the ratio of nickel to titanium. As is shown by curve 32 in FIG. 3B, the SMA wire element having a uniform ratio of nickel to titanium exhibits a very sharp displacement response as a function of time/temperature. In comparison, curve 34 shows that the SMA wire element 20 having a gradient along its length in nickel concentration exhibits a much more gradual displacement response as a function of time/temperature.

FIG. 2 depicts an exemplary embodiment where an SMA element exhibits a continuous gradation in a ratio of one metal to another metal in the shape memory alloy composition. In another exemplary embodiment, an SMA element can include a stepwise gradation in composition. FIG. 4 depicts an exemplary embodiment of an SMA element with such a stepwise gradation. In FIG. 4, SMA element 40 having a section 42 that is lean in titanium (e.g., from about 49 to about 50 at. %), a section 43 that has a higher concentration of titanium (e.g., from about 50 to about 51 at. %), and a section 44 that has an even higher concentration of titanium (e.g., from about 51 to about 52 at. %).

A shape memory element having a gradation in concentration of at least one of the metal elements of the alloy can be prepared by conventional metallurgical techniques known in the art. In an exemplary embodiment of an SMA element having a continuous gradient in concentration of at least one metal (e.g., FIG. 2), the element can be prepared by using conventional powder metallurgical techniques. Using such techniques, metal powders of the SMA component metals are dispensed into a suitable mold such that there is a gradation in the ratio of the powder amounts along a dimension of the mold shape. The powders in the mold are then heated under pressure to sinter the metal powder, thereby forming a solid element having a continuous gradient in the concentration of at least one of the metals in the shape memory alloy. The molded and sintered solid element itself can be used as an SMA element, or it can, using conventional wire forming techniques, be drawn along the concentration gradient dimension into a wire having a concentration gradient along its length.

A shape memory element having a stepwise gradation in concentration of at least one metal (e.g., FIG. 4) can be prepared using the powder metallurgical techniques described above.

In another exemplary embodiment, a gradation in phase change response can be provided by a gradation of concentration of an SMA metal in the crystal structure of the SMA element. Such a gradation in crystal structure can provide a gradation in phase change response even though the overall composition in weight percent or atomic percent of the shape memory alloy may be homogeneous. In one exemplary embodiment, a gradation in crystal structure is provided by a gradation in aging of the SMA element. During aging (exposure of the SMA element to increased temperature levels for periods of time), phases or crystal structures rich in one of the SMA metals can precipitate out of the crystal lattice structure of the shape memory alloy, which has the effect of depleting the concentration of that metal from surrounding areas of the lattice structure, thereby changing the localized phase change response of the shape memory alloy to thermal stimulus. In the exemplary embodiment of a Ni—Ti SMA, Ni-rich phases precipitate out of the Ni—Ti lattice during aging, depleting Ni from the surrounding lattice and thereby increasing the SMA phase transformation temperature. By exposing an SMA element to a gradation in aging conditions (e.g., varying temperatures and/or duration of exposure) along a dimension of the element, a gradation in the amount of precipitate rich in one of the metals (and thus a gradation in the amount of that metal left in the SMA lattice) can be achieved.

In another exemplary embodiment, a gradation in the phase change response of an SMA element can be provided by a gradation of the shape memory processing of the element. Shape memory processing (i.e., training) is typically performed to impart two-way shape memory effect (TWSME) to an SMA element. Such training generally involves heating the element to induce a phase transition in the shape memory alloy from Martensite to Austenite, cooling the element to induce a phase transition in the shape memory alloy from Austenite to Martensite, and cold working the Martensite shape memory alloy when it is in the Martensite phase. These steps are often repeated multiple times in order to impart a TWSME. Processing gradations along a dimension of an SMA element can be provided by variations along the dimension in the amount of strain applied during cold working (which impacts the formation of crystal structures such as twinned crystal structures), the temperatures to which the element is heated or cooled (which can impact the degree of conversion back and forth between Martensite and Austenite), or the number of repetitions to which portions of the SMA element are exposed. Gradations in shape memory processing can be imparted in a gradient fashion along a dimension of the SMA element or in a step-wise fashion along a dimension of the SMA element. Some of the above-described processing gradations (e.g., temperature gradations) can be readily imparted in either step-wise or gradient fashion, whereas others (e.g., strain gradations or gradations in the number of repetitions) are more readily imparted along a dimension of an SMA element in a step-wise fashion.

In another exemplary embodiment, a graded phase change response can be produced in an SMA element by utilizing embodiments of U.S. patent application Ser. No. _______ entitled “Spatially Graded SMA Actuators” (filed on Mar. 16, 2012 under attorney docket no. P010884-RD-SDJ), the disclosure of which is incorporated herein by reference in its entirety, to provide thermal variations in the SMA element that result in a graded phase change response. In one such exemplary embodiment, an SMA element is configured to undergo a graded thermal change along a dimension of the shape memory alloy element in response to thermal stimulus, thereby providing a graded phase change response in the element. In another such embodiment, the shape memory alloy element includes a gradation, along a dimension of the SMA element, in a ratio of surface perimeter to cross-sectional area in a plane perpendicular to the dimension, or in cross-sectional geometrical configuration in that plane. In yet another such embodiment, the SMA element has a coating thereon, where the coating includes a gradation, along a dimension of the SMA element, in cross-sectional geometrical configuration in a plane perpendicular to that dimension, or in thickness.

As discussed above, SMA elements such as SMA wires may be used as actuators for a variety of devices simply by attaching the ends of the wire to components the actuator is intended to act upon and subjecting the wire to thermal stimulus. SMA elements can also be integrated with other components to form an actuator. For example, an SMA wire may be encased in a sleeve for protection or to maintain its position or shape in a particular configuration.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

What is claimed is:

1. A shape memory alloy element configured to undergo a graded phase change along a dimension of the shape memory alloy element in response to thermal stimulus, thereby providing a graded displacement response of the element along said dimension.

2. The shape memory alloy element of claim 1, wherein the element comprises a plurality of metal elements, and includes a gradation, along said dimension, in a ratio of an amount of a first metal element to a second metal element.

3. The shape memory alloy element of claim 1, wherein the element includes a plurality of metal elements in a crystal lattice structure, and includes a gradation, along said dimension, in a ratio of an amount of a first metal element in the crystal lattice structure to a second metal element in the crystal lattice structure.

4. The shape memory alloy element of claim 1, wherein the element includes a gradation in shape memory effect induced by a gradation, along said dimension, in shape memory processing that includes heating the element to induce a phase transition in the shape memory alloy from Martensite to Austenite, cooling the element to induce a phase transition in the shape memory alloy from Austenite to Martensite, and cold working the Martensite shape memory alloy.

5. The shape memory alloy element of claim 4, wherein the gradation in shape memory processing includes a gradation, along said dimension, in cold working of the element.

6. The shape memory alloy element of claim 4, wherein the gradation in shape memory processing includes providing a gradation in temperature along said dimension while cold working the element during shape memory processing that includes heating the element to induce a phase transition in the shape memory alloy from Martensite to Austenite, cooling the element to induce a phase transition in the shape memory alloy from Austenite to Martensite, and cold working the Martensite shape memory alloy.

7. The shape memory alloy element of claim 1, wherein the graded phase change that the shape memory element is configured to undergo includes a step-wise graded phase change along said dimension.

8. The shape memory alloy element of claim 2, wherein the element includes a step-wise gradation in said ratio of the amount of first metal element to second metal element.

9. The shape memory alloy element of claim 1, wherein the element is 3, wherein the element includes a step-wise gradation in said ratio of the amount of first metal element to second metal element in the crystal lattice structure.

10. The shape memory alloy element of claim 4, wherein the gradation in cold working includes a step-wise gradation, along said dimension, in cold working of the element.

11. The shape memory alloy element of claim 5, wherein the gradation in temperature during cold working includes a step-wise gradation, along said dimension, in temperature during cold working of the element.

12. The shape memory alloy element of claim 1, wherein the graded phase change that the shape memory element is configured to undergo includes a continuous graded phase change along said dimension.

13. The shape memory alloy element of claim 12, wherein the graded phase change that the shape memory element is configured to undergo includes a step-wise graded phase change along said dimension.

14. The shape memory alloy element of claim 2, wherein the element includes a continuous gradation in said ratio of the amount of first metal element to second metal element.

15. The shape memory alloy element of claim 3, wherein the element includes a continuous gradation in said ratio of the amount of first metal element to second metal element in the crystal lattice structure.

16. The shape memory alloy element of claim 6, wherein the gradation in temperature during cold working includes a continuous gradation, along said dimension, in temperature during cold working of the article.

17. A method of shape memory processing of a shape memory alloy element, comprising heating the element to induce a phase transition in the shape memory alloy from Martensite to Austenite, cooling the element to induce a phase transition in the shape memory alloy from Austenite to Martensite, and cold working Martensite shape memory alloy, wherein a gradation, along a dimension of the element, in cold working is applied or a gradation in temperature is applied along said dimension during cold working.

18. The method of claim 17, wherein a gradation in cold working of the Martensite shape memory alloy is applied.

19. The method of claim 17, wherein a gradation in temperature is applied along said dimension during cold working.

20. A method of processing a shape memory alloy element, comprising heat treating the element at a temperature and for a time sufficient to alter the composition of a crystal lattice structure in the shape memory element, wherein a gradation, along a dimension of the element, is applied in temperature or duration of heat treatment.
